(19) United States
(12) Patent Application Publication
(10) Pub. No.: US 2009/0228361 A1
(43) Pub. Date: Sep. 10, 2009

(54) COGNITIVE SCHEDULER FOR MOBILE PLATFORMS

(76) Inventor: Eric S. Wilson, Los Angeles, CA (US)

Correspondence Address: Ketans S. Vakil;SNELL & WILMER L.L.P., Suite 1400, 600 Anton Boulevard, Costa Mesa, CA, 92626-7689, US

(21) Appl. No.: 12/401,571

(22) Filed: Mar. 10, 2009

Related U.S. Application Data
(63) Continuation-in-part of application No. 12/139,384, filed on Jun. 13, 2008.
(60) Provisional application No. 61/035,331, filed on Mar. 10, 2008.

(51) Int. Cl. G06Q 30/00; G06F 17/30

(52) U.S. Cl. 705/14; 707/3; 707/E17.014

(57) ABSTRACT

A computer-based method of scheduling creative assets for targeted distribution of a plurality of campaigns to a plurality of communications devices. The method includes receiving, at the database, an age code, a gender code, and a postal code corresponding to a user of each of the plurality of communications devices. The method also includes receiving, at the database, a campaign attribute for a plurality of campaigns, querying a targeting engine to obtain a number of impressions that satisfy the campaign attribute for each of the plurality of campaigns, receiving, at the database, a creative asset for each of the plurality of campaigns. The method also includes receiving, at the database, a business rule or a constraint for each of the plurality of campaigns, and creating a schedule for the plurality of campaigns based on the user profile data, the campaign attributes, the business rules or the constraints.

### CROSS REFERENCE TO RELATED APPLICATIONS

This application is a continuation-in-part of application Ser. No. 12/139,384 entitled “Cognitive Scheduler,” filed Jun. 13, 2008, and claims the benefit and priority of provisional application Ser. No. 61/035,331 entitled “Cognitive Scheduler for Mobile Platforms,” filed Mar. 10, 2008 and all assigned to the assignee hereof and hereby expressly incorporated by reference herein.

### BACKGROUND

1. Field

The invention relates generally to the field of digital content, and more specifically, to a system and method for providing a management platform for controlling when, where and how content is delivered and presented on a communications device.

2. Description of the Related Art

Improvements in communications technologies have led to an increase in the number of products/offerings provided by service providers (e.g., cable providers, internet providers, wireless providers, telephone companies, etc.), device manufacturers, content providers and companies offering and/or enabling value added services. Service providers offer numerous products which might include: voice services; data services such as text messaging and multimedia messaging; location based services; and internet access. Service providers also offer entertainment and a variety of content such as games, ring-tones and streaming music/video. As voice revenue diminishes and service providers become increasingly reliant on customers' use of data services and consumption of content, these service providers are continuously searching for ways to reduce costs, increase revenues and create new revenue streams to augment the declining average revenue per user (ARPU). Service providers measure their success by calculating ARPU.

Wireless devices have incorporated many improvements in wireless communication technologies. For example, traditional mobile phones now feature more memory, more processing capabilities and larger screens for the viewing of content. In order to maintain and/or increase market share and revenue, device manufacturers must integrate applications/features that increase ARPU for service providers. That is, service providers may choose to integrate applications/features that are a direct or indirect source of new revenues.

The communications industry has created stiff competition amongst service providers. That is, service providers must offer new content and access to content from third party providers in order to remain competitive in the marketplace. Furthermore, service providers must aggregate or develop content that matches the interests of their customers. Moreover, service providers must transform themselves into media companies and failure to do so may result in decreasing ARPU. The cost of providing increasingly sophisticated services and content may be offset if service providers increase ARPU. Hence, service providers must persuade their customers to use more of their products to remain viable.

Automation of business practices and procedures has led many organizations to implement a business model referred to as Customer Relationship Management (CRM). CRM enables organizations to effectively promote acquisition, retention and revenue optimization through the use of reliable systems, processes and procedures. CRM calls for the automation of basic business practices and the analysis of customer behavior and communication with customers through a variety of channels.

Service providers have long recognized the need to increase ARPU. One way to increase ARPU is through targeted, unobtrusive and engaging promotions and advertising. Content providers (e.g., advertisers, brands, marketers, promoters and media companies) have long recognized the mobile communications channel as a pervasive and powerful way of connecting with their desired consumers (i.e., consumers they want to reach). Content providers have been searching for an effective model by which mobile communications devices may become a new medium to reach consumers. The invention addresses these needs by providing a system and method that advances the art.

### SUMMARY

The invention comprises a system and a method for consumer engagement and revenue optimization. More specifically, the present invention may be used to connect wireless operators, advertisers and content providers with mobile communications consumers.

A computer-based method of scheduling creative assets for targeted distribution of a plurality of campaigns to a plurality of communications devices. The method includes receiving, at a server, device information from each of the plurality of communications devices, creating, at a database, a global unique identifier for each of the plurality of communications devices, and receiving, at the database, an age code, a gender code, and a postal code corresponding to a user of each of the plurality of communications devices. The method also includes receiving, at the database, demographic information corresponding to users residing within the postal code, receiving, at the database, a campaign attribute for a plurality of campaigns, querying a targeting engine to obtain a number of impressions that satisfy the campaign attribute for each of the plurality of campaigns, receiving, at the database, a creative asset for each of the plurality of campaigns. The method also includes formatting, at a content processor, the creative asset for each of the plurality of campaigns using the device information from each of the plurality of communications devices, receiving, at the database, a business rule or a constraint for each of the plurality of campaigns, creating a schedule for the plurality of campaigns based on the user profile data, the demographic information, the campaign attributes, the business rules or the constraints, and transmitting the schedule and the creative assets to the plurality of communications devices.

In one aspect, the method provides for the display of content on a communication device as a result of user actions that are intended to trigger events on the device unrelated to the display of the content. The content displays as soon as the user's action is taken. The length of the display is determined by the time necessary to actuate the event and may be visible until the intended event has been actuated. In some cases, a user's action might trigger an event on another user's device.

A repository may be provided whereby the user can intentionally access the content at the user's leisure. Some content, for example, a call to action or value proposition, might be available to a user for a limited period of time or require a response within a specified period of time. Users can interact with the content at the time it is displayed, thereby interrupting the intended event, or interact with the content as a result of accessing the content within the repository. Users can share content with others through various means. The repository may also be a means to facilitate user interaction which may involve mobile commerce.

In another aspect, the system includes a network, a management platform, and a communication device. The management platform may function as the network center for the entire system. The management platform may host a computer system, a database and a server. The system may be configured to communicate with providers of content, promotional sponsors and advertisers, collectively, content providers, internet and service providers, and communications devices. The system may update the database and may also store content; the database may store information about content providers. Consistent with the CRM model, the database may also store data associated with individual users or communications devices. The database is continually updated as information about individual users becomes available. The server may execute program scripts and may transmit content to and from targeted communications devices. The server may also transmit information about communications device usage and user responses which, in turn, may trigger additional content to be transmitted to targeted communications devices. A communications network may transmit data between the management platform and the communications device.

The communications device may host software that facilitates storage and presentation of content received from the management platform. Content may also be transmitted through the service provider, directly from content providers' servers, platforms, etc. The content may be displayed in real time or stored for later use. The display of content on the communications device may be the result of a user's actions that are intended to trigger events on the communications device unrelated to the display of the content. The content may be displayed as soon as the user's action is taken. The length of the display is determined by the time necessary to actuate the event; the display is visible until the intended event has been actuated. In some embodiments, a user's action may trigger an event on another user's device. A repository may exist whereby the user can intentionally access the content at the user's leisure. Some content, for example, a call to action or value proposition, might be available to a user for a limited period of time or require a response within a specified period of time. Users can interact with the content at the time it is displayed, thereby interrupting the intended event, or interact with the content as a result of accessing the content within the repository. Users can share the content with others through various means; users can also engage in mobile commerce directly from the repository.

For example, a display of content may be triggered by a user who places a call on a targeted communications device; content may be displayed while the communications device processes the call on both the sending and the receiving ends. Other designated actions and functions include launching a web browser, launching an application, uploading or downloading content or information, sending or receiving an SMS or MMS message, opening of a clam shell style device, or turning a device on or off.

### BRIEF DESCRIPTION OF THE DRAWINGS

The exact nature of this invention as well as its objects and advantages will be readily understood upon consideration of the following specification as related to the attendant drawings wherein like reference numerals throughout the drawings indicate like parts, and wherein:

FIG. 1 illustrates a block diagram of a Digital Sidebar system according to an embodiment of the invention.

FIG. 2 illustrates a block diagram of the management platform shown in FIG. 1 according to an embodiment of the invention.

FIG. 3 illustrates a block diagram of the communications device shown in FIG. 1 according to an embodiment of the invention.

FIG. 4 illustrates a block diagram of the management platform shown in FIG. 2 according to an embodiment of the invention.

FIG. 5 illustrates an exemplary menu displayed on the communications device shown in FIG. 3 according to an embodiment of the invention.

FIG. 6 illustrates exemplary targeted content displayed on the communications device shown in FIG. 3 according to an embodiment of the invention.

FIG. 7 illustrates a flow diagram of a first exemplary method to increase a service provider's ARPU or content provider's revenue according to an embodiment of the invention.

FIG. 8 illustrates a flow diagram of a second exemplary method to increase a service provider's ARPU or content provider's revenue according to an embodiment of the invention.

FIG. 9 illustrates a flow diagram of a third exemplary method to increase a service provider's ARPU or content provider's revenue according to an embodiment of the invention.

FIG. 10 is a flow diagram illustrating a method of providing mobile commerce in accordance with an embodiment of the present invention.

FIG. 11 is a flow diagram illustrating a method of providing mobile commerce in accordance with an embodiment of the present invention.

FIG. 12 is a simplified schematic illustration of a system for revenue generation and optimization in accordance with an embodiment of the present invention.

FIG. 13 is a simplified diagram of a system for allowing an advertiser or content provider to reach a targeted group of individuals that carry a communications device in accordance with yet another embodiment of the present invention.

FIG. 14 is a simplified diagram of a client application in accordance with an embodiment of the present invention.

FIG. 15 is a simplified diagram of a content scheduler in accordance with an embodiment of the present invention.

FIGS. 16A-16F are simplified illustrations of an embodiment of the present invention.

FIGS. 17A and 17B is a flow diagram of a method of scheduling content for targeted distribution of a plurality of campaigns to a plurality of communications devices in accordance with an embodiment of the present invention.

### DETAILED DESCRIPTION

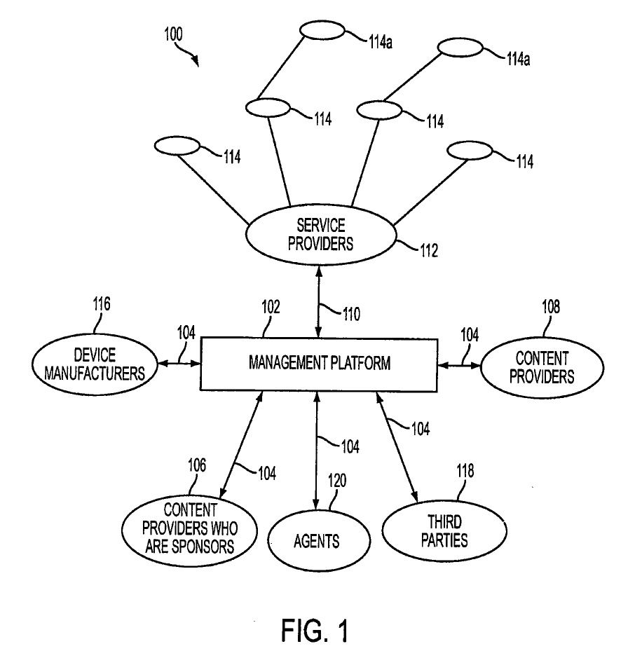

FIG. 1 illustrates a block diagram of a Digital Sidebar (DS) system 100 according to an embodiment of the invention. The management platform 102 functions as the nerve center of the DS system 100. The management platform 102 connects through the internet or other communication system 104 with content providers 108 and content providers 106 who are sponsors. The management platform 102 also connects with service providers 112 through, for example, a high bandwidth telephone line 110 (such as a T3 line), or other communication system (e.g., the internet). The content provider 108 or the service providers 112 may transmit data or content between the management platform 102 and the communications devices 114.

The internet 104 may provide the primary communications channel between the management platform 102, the content provider 108 and the service providers 112. However, telephone lines, power lines, cable, satellite, mail service and the like, may also be used. The high bandwidth telephone line 110 may provide the voice and/or data channel between the management platform 102 and the service providers 112. However, the internet 104 or a dedicated fiber, power line, satellite and the like may be used. The management platform 102 may be co-located with the service providers 112 or embedded in the service providers' 112 computer systems; it may also be centralized with an ASP or other third party 118. The service providers 112 may communicate with the communications devices 114 through a wireless network or via the internet. However, alternate embodiments may feature wired networks with wired communications devices 114.

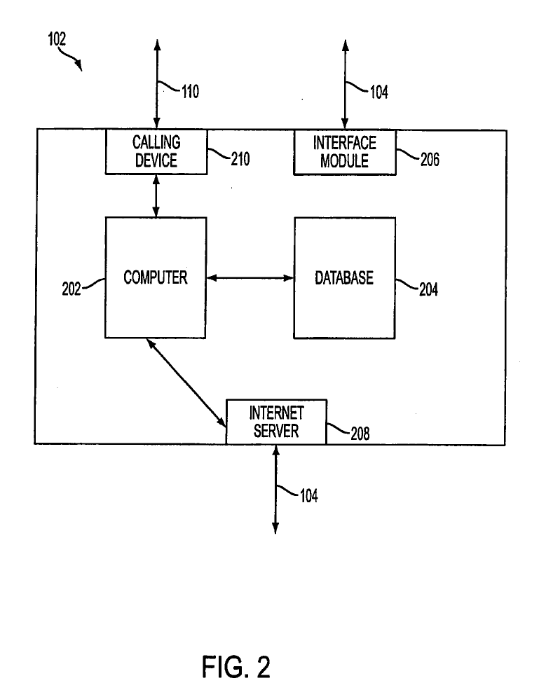

FIG. 2 illustrates a block diagram of the management platform 102 shown in FIG. 1 according to an embodiment of the invention. The management platform 102 may include a computer 202 which may have access to a database 204. The computer 202 may communicates with a user interface module 206 connected to the internet 104 via an internet server 208 also connected to the internet 104.

FIG. 2 illustrates the management platform 102 in a specific hardware topology according to an embodiment of the invention. However, many hardware and software topologies are contemplated. The computer 202, the database 204, the interface module 206, the internet server 208 and the calling device 210 may be hosted on a single computational platform or may be distributed over any number of platforms. For example, the computer 202 may be used to receive content, run scripts, and send targeted content, thus performing the functions of the internet server 208, the calling device 210 and the interface module 206. The devices may be co-located and communicate over a local area network or they may be distributed and communicate over a wide area network.

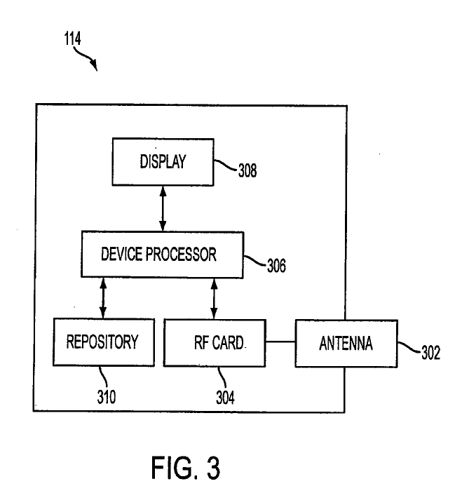

FIG. 3 illustrates a block diagram of a communications device 114 according to an embodiment of the invention. An antenna 302 may transmit and receive radio signals. An RF card 304 may convert the received radio signals from the antenna 302 into baseband signals to be processed by the device processor 306. The RF card 304 may also convert the baseband signals from the device processor 306 to modulated RF signals for transmission through the antenna 302. The device processor 306 may process the baseband signals and may drive a display 308 that displays content to a user. The device processor 306 may also manage a repository 310 where content may be deposited and/or stored for later use. The repository 310 may also serve as a portal for interaction with previously displayed content and related content, distribution of content to others, and mobile commerce.

The communications devices 114 may receive and transmit content through the bi-directional RF card 304 and the antenna 302. However, the communications devices 114 may be devices that are able to receive only such as televisions. The repository 310 may be flash memory, microprocessor cache, or any other type of memory storage device. The display 308 may comprise any type of display technology such as LCD, plasma, projection or picture tube. The use of devices, other than standard wireless devices such as mobile phones, Blackberries and Treos, is also contemplated. The DS system 100 may also be incorporated with personal computers, televisions, iPods and other devices with displays.

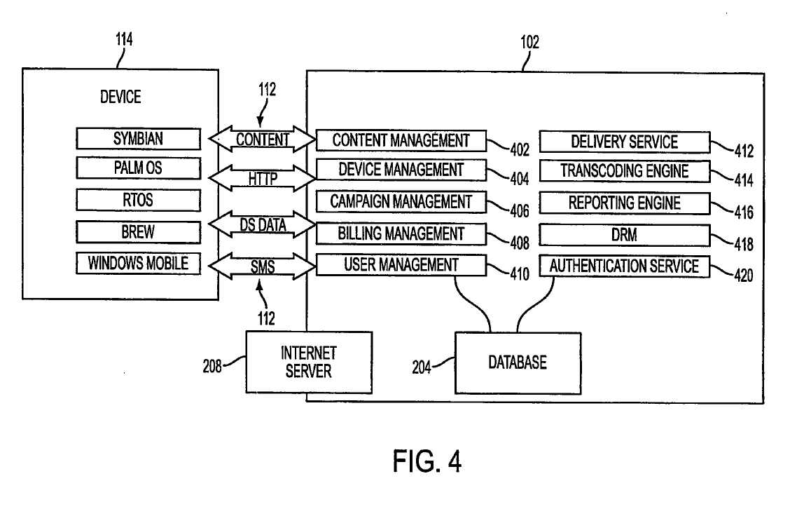

FIG. 4 illustrates some of the embedded functions of the DS system 100 according to an embodiment of the invention. The DS system 100 may be composed of the management platform 102 in communication with the communications devices 114 through the service providers 112. The communications devices 114 may request information about the content from the management platform 102 while the content is displayed on the display screen or after the content is displayed on the display screen. In one embodiment, the communications device 114 transmits data to or receives data from the management platform 102 in response to the user interacting with the content 602 on the display screen.

A variety of software objects provide input, output, data processing, and data management features. Each feature that may require a human interface may be made accessible via interface module 206.

A content manager 402 may receive content from the content providers 106 and 108. Alternatively, the content providers 106 and 108 may choose to transmit their content through their own platforms, an ASP or other third party platforms 118.

A device manager 404 may track the individual communications devices 114, their configurations and capabilities, and the content sent to each of the communications devices 114.

A campaign manager 406 may mine the database 204 for users to target for a promotional campaign, advertising campaign or other content, collectively, content. The campaign manager 406 may track demographic, psychographic, cybergraphic and geographic information of users; additional information such as the users' interests, responses to promotions, purchases and device usage may also be tracked. The campaign manager 406 may save the users' information in the database 204. The campaign manager 406 may use behavioral analytics, collaborative filtering or other means of predictive behavior modeling to target users.

A billing manager 408 may track user purchases and the content providers 106 and 108 information for billing records. The billing manager 408 may use message sent metrics or response metrics to generate invoices. A profile manager 410 may update the database 204 to reflect user characteristics, attributes, response patterns and device usage.

The profile manager 410 may update the database 204 using declared interests, gender, demographic, psychographic, cybergraphic and geographic information, credit history, responses to promotions, purchases or device usage.

A delivery service 412 manager may manage the delivery of content to the communications devices 114. The delivery service 412 manager may determine the type of content, the protocol and may track the number of times content is sent to a particular communications device 114.

A transcoding engine 414 may convert digital data into the appropriate data formats for data communication and data storage in the database 204. A reporting engine 416 may generate reports for delivery to the service providers 112, the content providers 106 and 108 or the campaign manager 406. A Digital Rights Manager (DRM) 418 may encrypt data and may manage policies, practices and procedures that properly manage data for the DS system 100. An authentication service 420 may provides data security for the content.

The management platform 102 functions may be automated or executed by individuals using a procedure set. In one embodiment, software objects provide most of the management platform functions. The software objects shown are exemplary and may be different in alternate embodiments. The DS system 100 may also be coded entirely using a functional architecture with no software objects.

The communications devices 114 may include enabling software that displays or stores content received from the management platform 102. The DS or similar software resident on the communications devices 114 may be coded using a variety of programming languages. A SIM card may be used to activate the DS system 100.

The communications devices 114 may support numerous operating systems, for example, without limitation, Symbian OS, Palm OS, RTOS, BREW, Windows Mobile, Android, JME, Smartphone: OS version 5 & 6, PocketPC: OS version 5 & 6 and the like.

The management platform 102 may be used to implement a business model that is a combination of CRM and a sponsorship or advertising sales initiative (hereinafter MONETIZED CRM). In MONETIZED CRM, the service providers 112, content providers 106 and 108, or agents 120 for the service providers 112 may sell media placements to sponsors, advertisers, promotional partners or content providers, collectively, content providers 106 and 108. Media placements may include promotions, promotional messages, advertisements or content, collectively, content, transmitted to and displayed on the communications devices 114. The content providers 106 and 108 may offer goods, services, prizes, coupons, or other consideration to the service providers' customers, content providers' customers, device manufacturers' customers or other users in exchange for a fee paid to the service providers 112, the content providers 106 and 108, the device manufacturers 116 or agents 120 for the service providers 112, the content providers 106 and 108 or the device manufacturers 116. The service providers 112, the content providers 106 and 108, the device manufacturers 116, or agents 120 for the service providers 112, the content providers 106 and 108 or the device manufacturers 116 may transmit the media placement to the targeted users' communications devices 114. The media placement may be independent of or combined with a promotion from the service providers 112, the content providers 106 and 108, or the device manufacturers 116 to its customers.

As part of MONETIZED CRM, the service providers 112, the content providers 106 and 108, the device manufacturers 116, or a third party 118 may update the database 204. The database 204 may store customer and user data. For example, the database 204 may associate a customer's phone number or a device's ISDN with purchases, downloads, internet-browsing and other behaviors. Once enough data is gathered, behavioral analytics, predictive behavior modeling and/or collaborative filtering may be used to determine which content selection should be sent to the communications devices 114.

Common subscriber profiling (CSP) may be used to enhance the database 204. CSP information may be acquired through self reporting, polling and surveying and may be an aggregation of gender, demographic information, psychographic information, cybergraphic information, geographic information, behavioral pattern information, and lifestyle information. A customer profile may emerge from the accumulated data allowing the service providers 112, the content providers 106 and 108, the device manufacturers 116, or their agents 120 to more effectively target content.

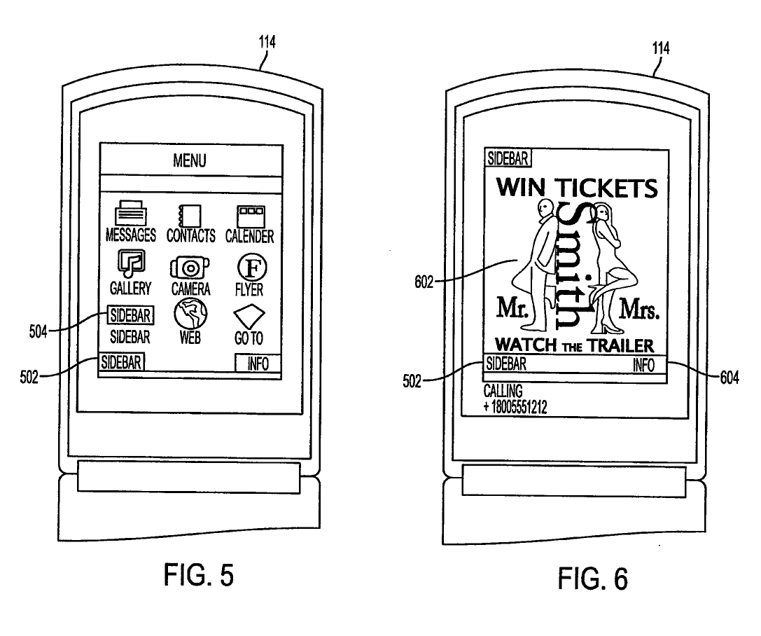

FIG. 5 illustrates an exemplary menu displayed on the communications device 114 shown in FIG. 3 according to an embodiment of the invention. The DS software, or other software which emulates the DS system 100 may be integrated into the operating system of the communications devices 114; a SIM card may also be used to emulate the DS system 100. A menu item 502 enables a user to access other menus that allow the user to select and display content stored in the repository 310. An icon or a soft key 504 on the display 308 of the communications device 114 may also provide access to the content.

Content available after selecting a menu item, an icon, or a soft key 504 may include information about goods and services offered, means by which to enter contests and promotions, personalized messages, content with embedded links to mobile portals, content with embedded links to the internet or WAP pages, interactive content and content with response mechanisms which enable a user to get data services or information from the service providers 112, the content providers 106 and 108 or the device manufacturers 116. There may be advertisements from sponsors 106 as well as a sponsor's 106 contact information. There may be menus or links that allow the user to communicate with the service providers 112, the content providers 106 and 108 or the device manufacturers 116 through the DS system 100. There may be a variety of goods and services displayed allowing the user to engage in mobile commerce. Additionally, users can share content made available through the DS system 100 with others. In one embodiment, a “share” function may allow content to be sent to or received from others via SMS, MMS, email, links, and the like.

In yet other embodiments, there may be menus or links that allow the user to become involved in social networking or social shopping. These features allow a user to inform or notify peers regarding the content that the user has interacted with, has consumed goods from (e.g. redeemed coupons), has made purchases from and other information about how the user is generally interacting with the content the user has received.

FIG. 6 illustrates exemplary targeted content (e.g., a promotional advertisement) 602 displayed on the communications device 114 shown in FIG. 3 according to an embodiment of the invention. The user may select an options button or icon or a corresponding soft key 604 to display more information about the targeted content 602. For example, in one embodiment, selecting options button 604 may cause a drop down menu to appear and provide the following or similar choices: Share—invokes an SMS window and gives the user the ability to share the targeted content 602 with others; More Info—takes user to a WAP or web page that gives user more information about the targeted content 602; Call—calls a number giving the user more information about the targeted content 602; and Video—opens a media player which allows the user to view a video or similar media associated with the targeted content 602. It should be understood that the targeted content 602 may be viewed as a static, audio visual, or an animated display.

The user may also select the sidebar button, an icon, a menu item or a corresponding soft key 502 for more information about the targeted content 602 or to access other targeted content 602 that has been stored in the repository 310. The display of the targeted content 602 may be triggered as a result of or in response to a user's designated action that is intended to trigger events on the communications device 114 that are related or unrelated to the display of the content 602. Media or content displayed when a triggering action occurs may be cached and stored in the repository or may be delivered in real time.

Displaying the content on the display screen is in response to the user's designated action on the communications device that is related or unrelated to the user's action or the actuated function on the communications device 114. In one embodiment, the user's action on the communications device 114 may cause a device event to occur on a second communications device 114a.

The targeted content 602 may be displayed as soon as the user's action or device event is initiated or completed. The displayed targeted content 602 may disappear automatically as soon as the intended event has been actuated. In some embodiments, the length of the display may be determined by the time necessary to actuate the event; the display may be visible until the intended event is actuated. In some embodiments, a user's action may trigger an event on another user's communications device 114a.

The targeted content 602 is displayed in the “unused space” of the display screen in communications device 114. For example, the unused space may refer to the space on the display screen that is not otherwise being used to display text or content. Alternatively, unused space may refer to space in the local file system, space in memory and the like.

The repository 310 may exist so that the user can intentionally access the content 602 at the user's leisure. Some content, for example, a call to action or value proposition, might be available to a user for a limited period of time or require a response within a specified period of time. Users can interact with the targeted content 602 at the time it is displayed thereby interrupting the intended event, or interact with the content as a result of accessing the content within the repository 310. The repository 310 may receive updated content after the communications device 114 transmits data to the management platform 102. The repository 310 stores the updated content in the communications device 114, and displays the updated content on the communications device 114 in response to an action which is or may be independent of making a request to display the updated content.

The user may interact with the targeted content 602, or related content stored or cached on the communications device 114, or related content not stored or cached on the communications device 114, while the targeted content 602 is displayed on the display screen or after the content 602 has been displayed on the display screen.

In one embodiment, the targeted content 602 may be conveyed to or displayed on the display screen in visual format, audio format or audio-visual format in response to a user's action requesting the content 602 from the repository 310. Alternatively, the content may be conveyed to or displayed on the display screen in visual format, audio format or audio-visual format between initiating the user's action and completing the user's action. And, alternatively, the content may be conveyed to or displayed on the display screen in visual format, audio format or audio-visual format until a user instructs the removal of the content.

The user may interact with the targeted content 602, related content stored or cached on the communications device, related content not stored or cached on the device, or functionality related to the content. Such functionality might include forwarding content to another device or user; accessing video, animation, music, games, graphics, text; accessing information; purchasing tickets, goods or services; placing a voice or data call; related to the content using the communications device while the content is displayed on the display screen or after the content has been displayed on the screen.

If the user interacts with the content 602, it may be displayed until the user instructs the communications device 114 to remove the content 602 from being displayed.

Designated actions on the communications device 114 may include, but are not limited to, launch of a web browser, launch of an application, uploads and downloads of content, opening a clamshell phone, sending or receiving a short message service (SMS) or multi media message service (MMS) message, placing of a phone call which causes the call to be received by another user's communications device 114a, and turning the communications device 114 on or off.

The content 602 may be stored in the repository 310 and accessed at the leisure of users. The repository 310 provides a library of content allowing the users to review content that has been displayed on the communications device 114, and additional related content, at their leisure. The repository 310 also allows users to interact with the content 602 or related content using the communications device 114 while the content is displayed on the screen or after the content 602 is displayed on the display screen, connect to the internet, connect to a WAP portal, connect to related content, share content with others through SMS, MMS, email and other links. The repository 310 is a means to facilitate user interaction which may involve mobile commerce.

The content 602 may also be pushed to or pulled by the communications device 114 to or from a second communications device 114a via standard IP and existing data bearers such as GPRS, EDGE, UMTS, CDMA, EV-DO or via cell broadcast technology, SMS, MMS, WAP. The content 602 may also take the form of an audio announcement or audiovisual display and announcement. The user's action on the communications device 114 may cause display of the content 602 on the second communications device 114a.

The service providers 112 or the content provider 106 and 108 may bundle its products with the promotion or other content. For example, games, ring tones, photo services, streaming music and video, digital video and satellite broadcasts, music and video on demand, news, weather, sports and entertainment updates; increasing customers use of products and services offered by the service providers 112 or content providers 106 and 108 and encouraging future use.

It should be noted that FIGS. 1-6 describe various embodiments and that there are many other embodiments including systems wherein a proprietary client, for example, software licensed from a third party is embedded in the software stack, chipset, or operating system of a communications device, and the proprietary client interacts with the native client, for example, the software developed by the device manufacturer or original equipment manufacturer. Other examples might include software which is embedded or downloaded to the application layer or firmware of targeted devices which provides an environment of similar interactive and immediate functionality as if the software were interacting with the native client in the devices; a SIM card might also enable this functionality. In some of these embodiments, the software may trigger a visual, audio or audio-visual display of content on the communications device 114 as a result of a user's designated actions that are intended to trigger actions or functions on the communications device 114 unrelated to the display of content; wherein the service providers 112, the content providers 106 and 108 or the third party 118, on behalf of the service providers 112 or content providers 106 and 108, may create the database 204 for storing customer related data; wherein the service providers 112, the content providers 106 and 108 or the third party 118, on behalf of the service providers 112 or the content providers 106 and 108, may maintain the database 204 for storing customer related data; where the service providers 112, the content providers 106 and 108 or the third party 118, on behalf of the service providers 112 or the content providers 106 and 108, may select a subset of the service provider's customers or the content provider's customers to receive a promotional announcement, advertisement or other content, collectively, content based on the customer-related data included in the database 204; where the service providers 112, the content providers 106 and 108 or the third party 118, on behalf of the service providers 112 or the content providers 106 and 108, may deliver content to a subset of the service provider's customers or the content provider's customers based on the customer-related data included in the database 204; where content 602 may be stored in the repository 310 within the communications device 114 and may be accessible to the user of the communications device 114; where content that may have been displayed on the communications device 114 may be stored in the repository 310 within the communications device 114 and may be accessible to the user of the communications device 114; where the repository 310 within the communications device 114 may provide a way for a consumer to contact the service providers 112 or the content providers 106 and 108 and may provide a means to request information about the content, goods, services and value propositions that have been delivered to the communications device 114; where the repository 310 within the communications device 114 may provide a way for a customer or user to enter contests, take advantage of value propositions offered by the service providers 112 or the content providers 106 and 108; and where the repository 310 within the communications device 114 may provide a way for a user to purchase goods, services or related content offered by the service providers 112 or the content providers 106 and 108 or other affiliated organizations; and where the repository 310 within the communications device 114 may provide a way for a user to link to additional content, information or services associated with the content stored in the repository 310; and where the repository 310 within the communications device 114 may provide a way for users to share content with others.

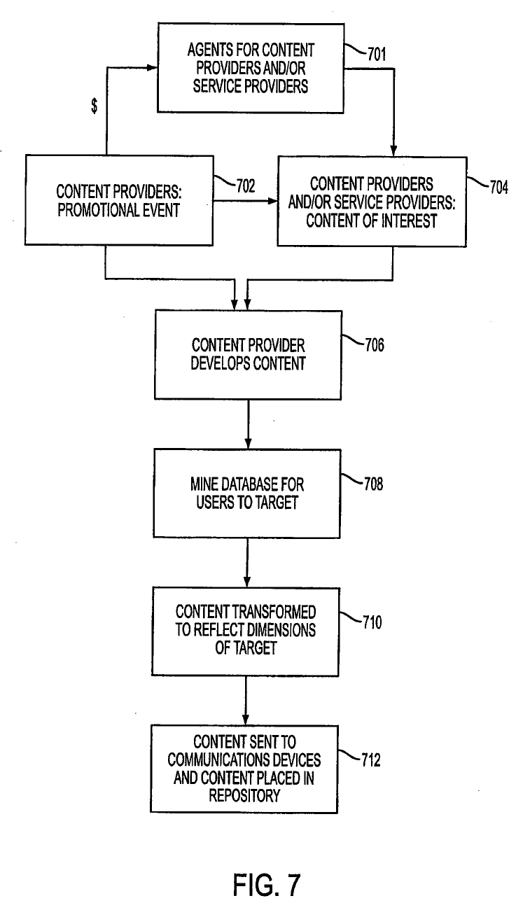

FIG. 7 illustrates a flow diagram of a first exemplary method to increase the service providers' 112 ARPU, the content providers' 106 and 108 revenues, or the device manufacturers' 116 revenues according to an embodiment of the invention. In step 702, the content providers 106 and 108 may sponsor a promotional event and pay money to the agents 120 (step 701), the service providers 112, the device manufacturers 116 or the content providers 108 to generate awareness about the promotional event. For example, to advertise a new music release the content providers 106 and 108 may want to offer a chance to win two free tickets with backstage pass to the concert of the artist who has recorded the new release. In step 704, the service providers 112 or the content providers 106 and 108 may have content to be advertised or promoted. For example, a service provider 112 may wish to advertise that availability of audio streaming over communications devices 114. In step 706, the content providers' 106 and 108 promotion or advertisement may be bundled with a sample of the service provider 112 or content providers' 106 and 108 contents. For example, a promotion may be developed and it may notify users or customers that they can win two tickets to the artist's concert with a backstage pass. A text line saying that free-streaming audio is available to the user and is sponsored by a music network or an athletic shoe company (the music network may be airing a live special of the artist and the athletic shoe company might employ the artist as a spokesperson).

In step 708, the management platform 102 may mine the database 204 to find communications devices 114 of users to target. Users may be targeted based on demographic data, behavior profiles, actions that have occurred on the device or expressed interest.

In step 710, the content may be transformed to more accurately reflect the dimensions of the target device. To that end, the management platform 102 may convert the promotional content into digital format using data formats and protocols consistent with the communications devices 114 that have been targeted.

In step 712, the promotions or advertisements may be sent to the communications devices 114 for immediate display or for placement in the repository 310 for display triggered as a result of users' designated actions on the communications device 114.

This method may increase ARPU for the service providers 112 because it may generate sponsorship or advertising revenue from the content providers 106 and 108 and because it may increase the likelihood that the communications device 114 users may expand their use of the content and data services offered by the service providers 112. In the above example, many users may choose to utilize the audio streaming features of their communications devices 114, thus increasing purchases of audio streaming and use of the service providers' systems resulting in revenues for the service providers 112 and the content providers 106 and 108 of streaming audio; users might also choose to share the content with others via MMS, SMS, email or other links which may increase the use of data services offered by the service providers 112. The device manufacturers' 116 revenue may be increased if they receive a percentage of the revenue resulting from advertising content that has been transmitted to the communications devices 114 in which they have integrated the DS software or a similar system. Targeting content based on related criteria or analytics may increase the likelihood that it will be relevant to the users who view it.

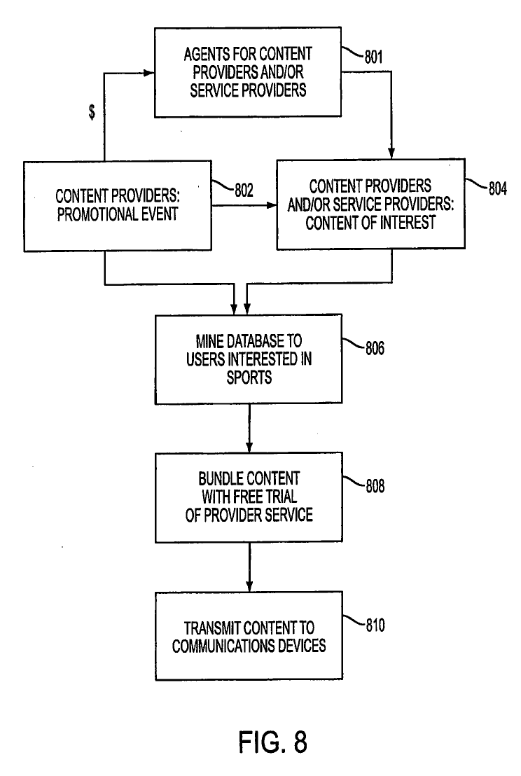

FIG. 8 illustrates a flow diagram of a second exemplary method to increase the service providers' ARPU, the device manufacturers' revenues and the content providers' revenues according to an embodiment of the invention. In step 802, the content provider 106 and 108 may have a promotional event it would like to advertise. For example, a sports league may want to advertise a drawing for a free trip to the playoffs and a credit card company that sponsors the sports league may want to participate in the promotional event; the credit card company may agree to provide gift checks to the winner of the trip and to sponsor the promotion. The credit card company may then pay the service provider 112 or the agent 120 for the service provider 112 (step 801) a fee for advertising the promotion.

In step 804, the service provider 112 may identify relevant content or services that it may want to promote. In step 806, the service provider 112 or the agent 120 for the service provider 112 may mine the database 204 to search for users to target with the promotion.

In step 808, a free trial period for the service provider's selected content may be bundled with the content provider's 106 and 108 promotion. For example, the service provider's customer who enters the drawing may receive a 60-day trial of the service provider's sports information updates.

In step 810, the bundled promotion may be sent to the targeted communications devices 114.

This method may increase ARPU for the service provider 112 by exposing sports fans to its content, thereby increasing the chance that the customers who received the free content will buy similar content once the free trial ends; the service provider 112 also receives advertising revenue from the content providers 106 and 108. The content providers 106 and 108 also receive the added benefit of increased interest in the promotion since the targeted customers or users may be more interested in the sports updates than other customers or users. The device manufacturers' 116 revenues may be increased if they receive a percentage of the revenue resulting from advertising that has been transmitted to communications devices 114 that have integrated the DS software or a similar system. The content provider's 106 and 108 revenue may be increased when users purchase sports content available through their communications devices 114.

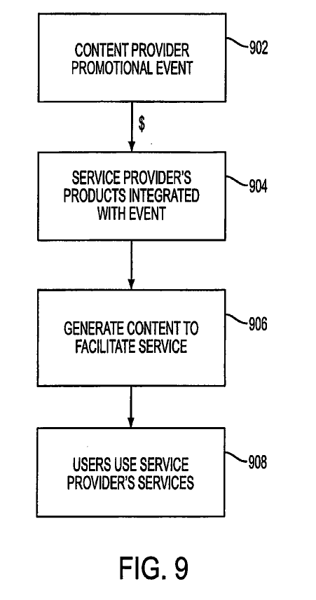

FIG. 9 illustrates a flow diagram of a third exemplary method to increase the service providers' ARPU, the device manufacturers' 116 revenues and the content providers' 106 and 108 revenues according to an embodiment of the invention. In step 902, the service providers 106 and 108 may want to increase use of MMS on the communications devices 114 and identifies a promotional event. The service providers 112 or the service providers' agents 120 may find a television studio that wants to promote a particular program. The television studio may sponsor a promotion for a casting call; customers may enter the promotion by sending their pictures via MMS on their communications devices 114. In step 906, the service providers 112 or the service providers' agents 120 may mine the management database 204 for the service providers' 112 customers who may be interested in the casting call; a promotional advertisement may be created to notify the users of the content providers' 106 and 108 event and how they may participate using their communications device 114 or alternative means. For example, the advertisement may say there is a casting call for young adults who have undiscovered talents and explain how to enter the casting call by sending their photographs using their communications device 114. In step 908, the user may send the photograph via MMS to enter the casting call.

This method may increase ARPU by generating advertising revenue for the service providers 112, as well as by increasing the use of the service providers' MMS services. In addition, the service providers' customers may become knowledgeable about the MMS data services available to them. This soft introduction to the service providers' 112 MMS service may generate revenue if the customer uses the MMS service in the future. The device manufacturers' 116 revenues may be increased if they receive a percentage of the revenues resulting from advertising that has been transmitted to communications devices in which they have integrated the DS software or a similar system. The content providers' (i.e., the studio) 106 and 108 revenues may be increased when the television show attracts more viewers; this may result in higher ratings and increased revenues from advertising sales. The studio might also sell content, associated with the television show, e.g., ring tones and graphics for the communications devices 114.

It should be noted that the methods described in FIGS. 7-9 are exemplary embodiments. Other embodiments include the variations, where multiple service providers 112 and/or content providers 106 and 108 are involved. The service providers 112 may receive revenues from the content providers 106 and 108 for the media placement and for transmitting the content to its customers or users; where the content that notifies the customer or user about the event, goods or services of the content provider 106 and 108 may be paid for by the content provider 106 and may include a promotion regarding goods and services offered by the service provider 112 or the content provider 106 and 108; where the event may be a contest or a promotion that includes a prize offered by the content provider 106 and 108 or its affiliates; wherein the event is a value proposition, e.g., prizes, free trials of goods or services, free goods, free services, coupons or discounts offered by the content provider 106 and 108 or the service provider 112; where the promotion may be an integrated marketing effort on behalf of the service provider 112 or the content provider 106 and 108 where the event offered by the service provider 112 or the content provider 106 and 108 may be a quiz or a game involving a dialogue with customers or users; where the service provider 112 or the content provider 106 and 108 may provide goods or services for free for a trial period to customers or users who receive the promotion; where the goods or services provided by the service provider 112 or the content provider 106 and 108 to the customer may be promoted by the content provider 106 and 108; where the service provider 112 or the content provider 106 and 108 or a third party 118 may create and maintain the database 204 for storing customer-related data; where the service provider 112 or the content provider 106 and 108 may select a subset of customers or users to receive the promotion based on the related data included in the database 204; where the service provider 112 or the content provider 106 or 108 may receive additional revenues from customers or users that use the goods and services beyond the end of the trial period; where the customer or user notifies others of the event, the others may contact the service provider 112 or the content providers 106 and 108 and may request new services, new products, information about products and/or services or may request that they be added to the database 204, and the service provider 112 or the content provider 106 and 108 may gain the opportunity to earn revenues from these customers; where the customer or user may notify others of the event and this results in viral marketing which ultimately increases the revenues for the service provider 112 or the content provider 106 and 108; where the service provider 112 may issue an announcement in other media or display formats regarding the event or the goods and services provided by the service provider 112 or the content provider 106 and 108; where the content provider 106 and 108 may issue an announcement in other media or display formats regarding the event or the goods and services provided by the content provider 106 and 108 or the service provider 112; (where the repository 310 for storing customer-related data may be embedded in a software stack included in the communications device 114; where the repository 310 for storing customer-related data may be embedded in a chipset included in a communications device 114; where the repository 310 for storing customer-related data may be embedded in an operating system, firmware, middleware or application layer of a communications device 114; where the repository 310 for storing content may be embedded in a software stack included in the communications device 114; wherein the repository 310 for storing content may be embedded in a chipset in a communications device 114; where the repository for storing content may be embedded in the operating system, firmware, middleware or application layer of a communications device 114.

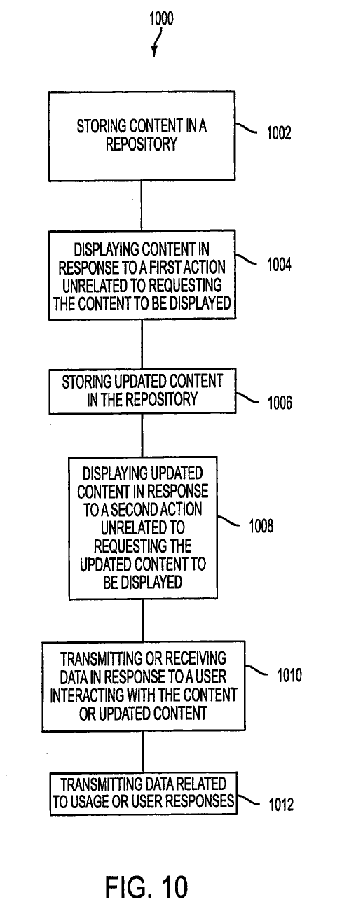

FIG. 10 is a flow diagram illustrating a method 1000 of providing mobile commerce. In step 1002, targeted content 602 may be received and stored in repository 310 of mobile communications device 114.

In step 1004, the content 602 may be displayed on, for example, a display 308 of the mobile communications device 114 (FIG. 3). The display may be made in response to a first action unrelated to the action of requesting the targeted content 602 to be displayed. In one embodiment, the display may be made between the initiation of the first action and the completion the first action.

In one embodiment, the first action may include, but is not limited to, a launch or ending of a web browser or an application, a placing or receiving of a phone call, a sending or receiving of an SMS or MMS, an opening of a clamshell communications device, a turning on or off of the communications device, and an uploading or downloading of content.

In step 1006, repository 310 receives and stores new or updated content in the repository of the mobile communications device 114. The updated content may replace or be stored in addition to the targeted content 602 originally received and stored in step 1002.

In step 1008, the updated content may be displayed on the display screen of the mobile communications device 114 in response to a second action which is independent of making a request to display the updated content between initiating the second action and completing the second action. Although the second action may include the same types of actions as the first action, the second action may be different from the first action.

In step 1010, data may be transmitted or received in response to a user interacting with the content or the updated content that is displayed on the display 308.

In step 1012, the mobile communications device 114 may transmit data related to usage and the like, including a users responses to the content or updated content.

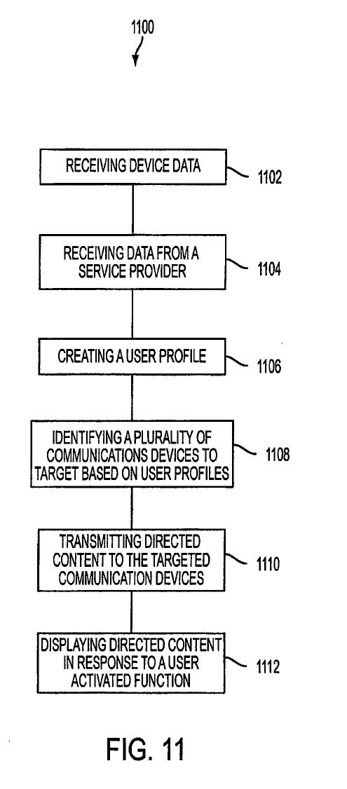

FIG. 11 is a flow diagram illustrating a method 1100 of providing mobile commerce. In step 1102, device data about a user's actions may be received from communications device 114.

In step 1104, data may be received from, for example, a wireless service provider about the communications device 114. The provider data may include information related to usage of the communications device 114, responses from the communications device 114, and a profile of a user of the communications device 114.

In one embodiment, data may be received from a service provider providing Location Based Services (LBS). The LBS are information and entertainment services accessible with mobile devices through the mobile network and utilizing the ability to make use of the geographical position of the mobile device. LBS services include services to identify a location of a person or object, such as discovering the nearest gas station or the location of an employee. LBS services may also include parcel tracking and vehicle tracking services.

In operation, the service provider acquires the desired location of a user based on the radio signal delay of the closest cell-phone towers (for phones without GPS features). This location data can be added to the profile of the user. Alternatively, since newer communications devices typically have an A-GPS chip built-in, using a Server User Plane Level or SUPL network, the A-GPS chip may provide a location.

In step 1106, a user profile may be created using the device data and the provider data. The user profile may include, but is not limited to, information related to a user's interests, age, gender, location at a given time, including the time of day, the day of the week, credit information, usage patterns, web browsing patterns, purchases, downloads, behavioral patterns, lifestyle information, the type of the communications device, and the wireless network provider. In one embodiment, the profile may be created using profile based on the user's real world associations to other users (collaborative filtering).

In step 1108, the user profiles may be used to identify a plurality of communications devices 114 to target for receiving directed and specific content based on the user profiles. For example, content may be directed to communications devices 114 located in a certain geospatial location to ensure that a User is near a location being promoted in the content.

In step 1110, the directed content may be transmitted to the plurality of targeted communications devices 114.

In step 1112, the directed content may be displayed in response to a user-actuated function on the communications device 114. For example, when a user has an incoming call, targeted content 602 is displayed until the call has been answered or ignored. When the call ends, an “actionable” content window may be presented. If the user does not “take action” or click on one of the icon or soft keys 504 and 604 presented, the content 602 may disappear, for example, in 3 seconds or so.

If the user chooses to see more information, a “Keystone” Image (i.e. a specific form of targeted content 602) may appear. If the user chooses not to see more information, the user may choose at a later time to browse all of the content stored in repository 310 for selective viewing.

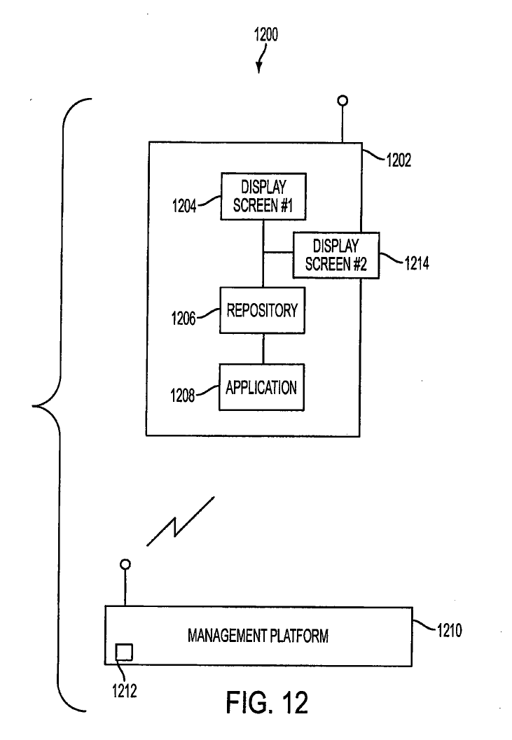

FIG. 12 is a simplified illustration of a system 1200 for revenue generation and optimization in accordance with an embodiment of the present invention. The system 1200 may include a communications device 1202 having a display screen 1204, a repository 1206 coupled to display screen 1204 for storing content, and a client application 1208 for displaying the content on the display screen 1204 as a result of a user's action on the communications device 1202. In one embodiment, the client application 1208 displays the content on the display screen 1204 as a result of the user's action requesting display of the content.

The system 1200 also includes a management platform 1210 having a database 1212 for storing the content. The database 1212 also stores information about the communications device 1202 and/or the user of the communications device 1202. In one embodiment, based on the information stored about the communications device 1202 and/or the user, content may be transmitted from database 1212 wirelessly between the management platform 1210 and the communications device 1202. The content may include, but is not limited to, an advertisement, media, a promotion, a call to action, a value proposition, and combinations thereof. The media may further include a game, ring tone, photo service, music, video, streaming audio, streaming video, streaming audio-video, digital video broadcast, digital satellite broadcast, music on demand, video on demand, music-video on demand, news, weather, sports and entertainment, audio announcement, and audiovisual display and announcement.

In one alternative embodiment, system 1202, may include a second display screen 1214 also coupled to repository 1206. In this embodiment, second display screen 1214 may be used to display content, such as but not limited to, a web page, an email message, an application program, or any other content that may be the same, related to, or completely different from the content being displayed on the display screen 1204.

In one embodiment, the user may interact with the primary display of content, related content stored or cached on the communications device, related content not stored or cached on the device, or functionality related to the content. Such functionality might include forwarding content to another device or user; accessing video, animation, music, games, graphics, text; accessing information; purchasing tickets, goods or services; placing a voice or data call; related to the content using the communications device while the content is displayed on the display screen or after the content is displayed on the screen.

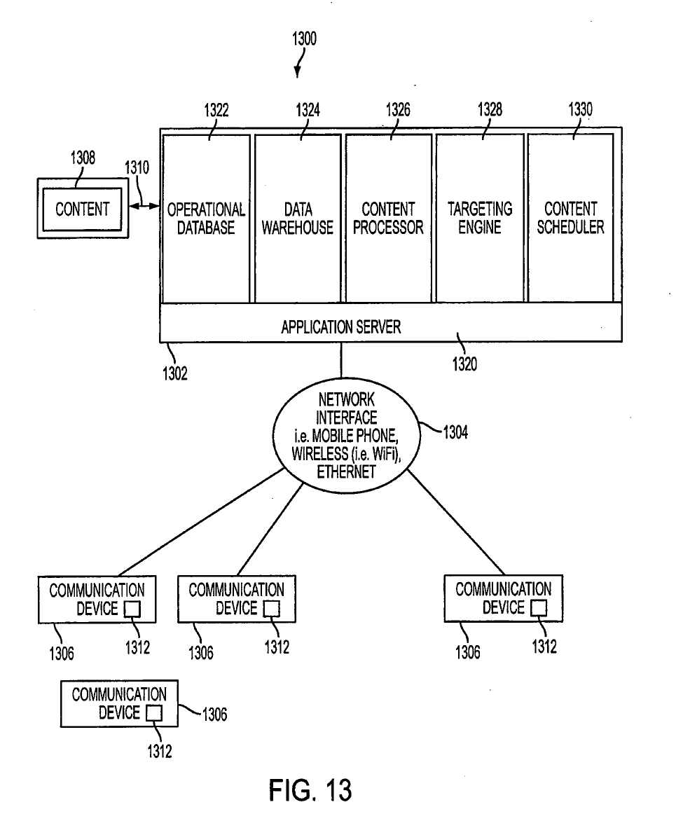

FIG. 13 is an illustration of a system 1300 for allowing an advertiser or content provider to reach a targeted group of individuals that carry or have a communications device 1302 in accordance with yet another embodiment of the present invention. In one embodiment, the system 1300 includes a management platform 1302, a network interface 1304 and at least one communications device 1306. The content 1308 is identified, created and conveyed to the system 1300 as a Campaign ID (CID) 1310.

In one embodiment, the management platform 1302 receives the CID 1310, manages the targeted individuals selected to receive content 1308 and manages the lifecycle of the content 1308. In one embodiment, the content 1308 via CID 1310 is received by the system 1300, formatted and bundled for delivery to at least one communications device 1306. The communications devices 1306, such as Blackberrys, mobile phones, MP3 players, laptops, computers, televisions or other typical modern communications devices, may include applications designed to support the management platform 1302 as detailed below.

In one embodiment, the system 1300 provides for the creation and transfer of inventory. Inventory is dynamic in nature and is defined as the total number of opportunities in a given time period that an impression may be delivered. An impression is defined by the unique opportunity to deliver content 1308 to the targeted individual. The CIDs 1310 are stored in the management platform 1302 for dissemination to the communications devices 1306. The management platform 1302 provides an efficient, timely and targeted dissemination of the CIDs 1310 to the communications devices 1306 and the delivery of content 1308 to the local cache of the communications devices 1306 before the content 1308 is to be displayed, all of which optimizes revenue generation for the advertiser and exposure for the content provider.

Referring to FIG. 13, the management platform 1302 (e.g., application server 1320) communicating with an application 1312 resident or stored on the communications device 1306 provides a powerful mechanism for controlling when, where and how content 1308 is delivered and presented on the communications device 1306.

The fundamental applications used to manage this process exist on the management platform 1302 and the communications device 1306. In one embodiment, the management platform 1302 includes an application server 1320 configured to host an operational database module 1322, a data warehouse module 1324, a content processor module 1326, a targeting engine module 1328 and a content scheduler module 1330.

Operationally, the application server 1320 hosts the application that interfaces with the content or service providers and the backend of system 1300. The application server 1320 provides services to the client application 1312 and provides for the interconnectivity between all other server side components in the system 1300. In one embodiment, the application server 1320 may use any markup languages, which are artificial languages using a set of annotations to text that describe how text is to be structured, laid out, or formatted, such as Extensible Markup Language (XML), to facilitate the sharing of structured data across different information systems, particularly via the Internet. The application server 1320 may encode documents and serialize data to communicate to the service provider system as well, using XML or such other text-based serialization languages as JSON and YAML. The application server 1320 also includes interface software to the targeting engine module 1328, the operational database module 1322 and the data warehouse module 1324.

The operational database module 1322 includes all data sets required for daily operation of the system 1300. For example, the operational database module 1322 manages the schedule, affinity group bundles of content, start and end of campaign information and the information flow for optimum usage of network resources.

The data warehouse module 1324 includes a complete history of all data created and managed by system 1300. For example, the data warehouse module 1324 may compile data, such as, but not limited to, usage trends, behavioral analysis, patterns and helps and the like to aid in determining potential future inventory needs. The data warehouse module 1324 may also provide detailed information about impressions delivered. In one embodiment, the data warehouse module 1324 manages and stores the aggregate data collected on the user actions from the communications devices 1306, data on calling and usage patterns, and the number of impressions delivered and the number of opportunities for the impressions to be seen.

The content processor module 1326 manages the ingestion and manipulation of content. The content processor module 1326 creates tailored variations of the ingested content relative to the targeted screen dimensions of the targeted communications device 1306. The content processor module 1326 also provides for the automated packaging of processed content, which enables efficient distribution.

The targeting engine module 1328 refines the generated consumer or user profile based on consumer or user actions and consumer or user data input. The targeting engine module 1328 provides the content that is most relevant to the consumer as determined by a percent fit. For example, the higher the percent fit (closest to 100%) the more accurately targeted the content is toward the consumers' interests. The determination of percent fit is derived from the consumers' action or inaction toward content that has been presented on the communications device 1306 to the consumer in the past. The targeting engine module 1328 divides the group of communications device users into targeted subsets that enable delivery of timely content to users.

The content scheduler module 1330 provides for the management, segmentation and delivery of content or inventory. In this embodiment, the content scheduler module 1330 builds and maintains the dates and times of programmed content display. The content scheduler module 1330 takes the information from the targeting engine module 1328 and controls when the user sees the content based on, for example, a set of rules.

It should be understood that as used herein, the term Ad refers to an advertisement and as such is a subset of the targeted content. Accordingly, the term Ad is used only to exemplify the present invention and is not intended to limit the present invention.

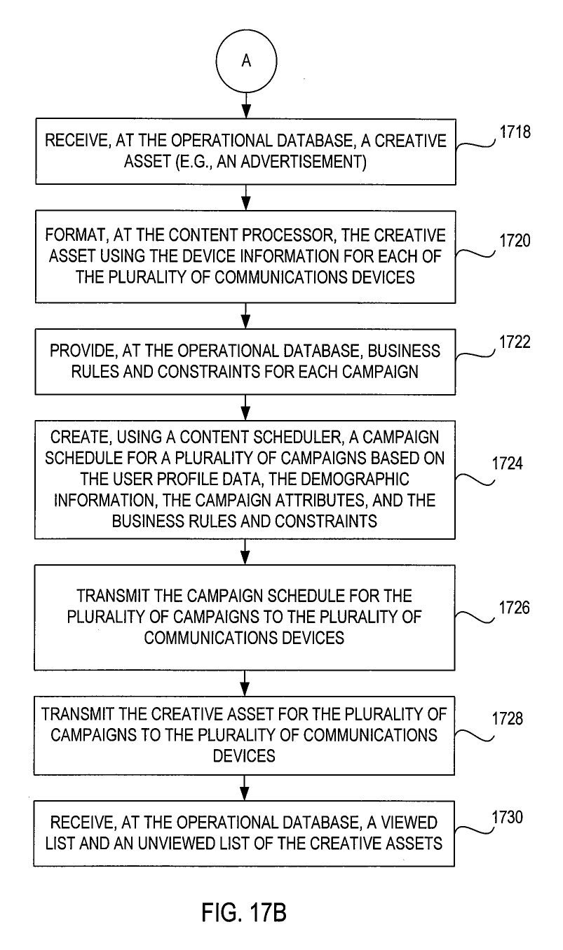

FIGS. 17A and 17B is a flow diagram of a method of scheduling content for targeted distribution of a plurality of campaigns to a plurality of communications devices 1306. In one embodiment, the communications device 1306 (i.e., the client application 1312) may make a request to the application server 1320 for a sidebar application, which allows the communications device 1306 to receive schedules and targeted content from the application server 1320. The request may include device information about the communications device 1306 such as the model number or type of communications device 1306. The device information may be stored with the user profile data discussed below. At step 1702, the operational database 1322 creates a global unique identifier (GUID) for each communications device 1306. The GUID may include the phone number of the communications device 1306 and/or other unique identification data.

During the installation of the sidebar application on the communications device 1306, the user may complete an optional registration form that may include user profile data such as age, gender, and postal code of the user. The age may be input as a birthday or an exact age. During the registration process or based on the user's selection of a creative asset, the user profile data may be manually or automatically updated with information such as the user's type of music, car, drink, age, geographic region, social networks, television shows, movies, sporting events, sports, likes, dislikes, etc. For example, if the user selects a Starbucks Ad to view, the communications device may send this information to the operational database 1322 to update the user profile data to include Starbucks as the type of drink. The user profile data may be stored in the operational database 1322 (step 1704).

The operational database 1322 may receive demographic information based on the postal code (step 1706). For example, the demographic data may include the average household income, the average number of children per household, the types of jobs, the average number of cars, the types of cars driven, etc. for the postal code or a region of several postal codes that includes the postal code received by the user. The demographic data may be created or purchased from a provider such as Nielson.

At step 1708, a company, desiring to schedule and provide content to a plurality of communications devices 1306, may provide campaign attributes for a campaign to the operational database 1322. The campaign attributes are characteristics of users that the company would like to target using its creative asset. The campaign attributes may include personal characteristics of the targeted users of the communications devices 1306. For example, the campaign attributes may specify one or more of the following: type of music, car, soda, age, geographic region, social networks, television shows, movies, sporting events, sports, likes, dislikes, etc. Each campaign attribute can be set to a percentage fit ranging from 0 percent to 100 percent (step 1710).

The targeting engine 1328 is queried to obtain a number of impressions that satisfy one or more of the campaign attributes for the campaign (step 1712). An impression is an opportunity to display a creative asset (e.g., an advertisement) based on or in response to an action or event that occurs on the communications device 1306. In one embodiment, the targeting engine 1328 determines which of the plurality of communications devices 1306 has user profile data that satisfies one or more of the campaign attributes for the campaign. Each communications device 1306 may have an average number of impressions, e.g., 10 per day. The total number of impressions for all the communications devices 1306 that satisfy the one or more campaign attributes for the campaign is the number of impressions provided by the targeting engine 1328. The targeting engine 1328 may provide the number of impressions for the campaign to the operational database 1322 and/or the company via email or a Campaign Administration Tool (step 1714). The company may access the application server 1320 and obtain or view the number of impressions for the particular campaign using a password. The company may also modify or change the campaign attributes and/or the percentage fit for each campaign attribute if desired, for example, if the number of impressions is too large or too small.

Once the company is satisfied with the number of impressions for the particular campaign, the company accepts the campaign and the operational database 1322 assigns a campaign ID to the campaign (step 1716). The company uploads the creative asset(s) or data links (e.g., streaming video) corresponding to the campaign to the operational database 1322 (step 1718) and the creative asset is formatted for a plurality of different communications devices 1306 (step 1720). The operational database 1322 may use the device information for formatting purposes. The creative asset is formatted because each communications device may have a different screen size and different available memory. A number of different campaigns may be created and scheduled for distributions to one or more communications devices 1306.

The company or an administrator of the application server 1320 provides business rules and constraints for each campaign (step 1722). Constraints—Constraint programming is a programming paradigm where relations between variables are stated in the form of constraints. Constraints differ from the common primitives of imperative programming languages in that they do not specify a step or sequence of steps to execute, but rather the properties of a solution to be found. This makes Constraint Programming a form of declarative programming. The constraints used in constraint programming are of various kinds: those used in constraint satisfaction problems (e.g., “A or B is true”), those solved by the simplex algorithm (e.g., “x<5”), and others. Constraints are usually embedded within a programming language or provided via separate software libraries. Business Rules—A business rule is a statement that defines or constrains some aspect of the business. A business rule is intended to assert business structure or to control or influence the behavior of the business. Individual business rules that describe the same facet of an enterprise are usually arranged into business rule sets. Business rules describe the operations, definitions and constraints that apply to an organization in achieving its goals. For example, a business rule might state that no credit check is to be performed on return customers. Others can define a tenant in terms of solvency or list preferred suppliers and supply schedules. These business rules are then used to help the organization to better achieve goals, communicate among principals and agents, communicate between the organization and interested third parties, demonstrate fulfillment of legal obligations, operate more efficiently, automate operations, perform analysis on current practices, etc. The business rules and constraints may be stored in the operational database 1322 or rules based engine.

The content scheduler 1330 creates a schedule for a plurality of campaigns based on one or more of the following: the user profile data, the demographic information, the campaign attributes, and the business rules and constraints (e.g., time of day) (step 1724).

The content scheduler 1330 transmits the schedule for a plurality of campaigns to a plurality of communications devices 1306 (step 1726). Alternatively, one or more of the plurality of communications devices 1306 may request a schedule from the content scheduler 1330. During the same transmission as the schedule or thereafter, the content scheduler 1330 transmits the creative asset for the plurality of campaigns to the plurality of communications devices 1306 (step 1728). The schedules and/or the creative assets may be simultaneously downloaded to the communications devices 1306 for displaying in real-time or may be stored or cached on the communications devices 1306 for being displayed at a future time on the communications devices 1306.

Each of the plurality of communications devices 1306 creates a viewed list of viewed creative assets, the time each creative asset was viewed, and the event which triggered the viewing and an unviewed list of unviewed creative assets. An example of a viewed list is:

Starbucks Advertisement 8:20 am SMS Text Message

At the end of each day or each week, each of the plurality of communications devices 1306 transmits the viewed list and the unviewed list to the operational database 1322, the data warehouse 1324 and/or the targeting engine 1328 (step 1730). The content scheduler 1330 may reschedule only the creative assets that were on the unviewed list to be displayed on the communications device 1306 to allow the company to try to reintroduce the unviewed creative assets to the user at, for example, a different day and/or time of day.

A rule-based scheduler such as the content scheduler 1330 may be grouped into two categories: 1) per promotional campaign; and 2) per user constraints.

In one embodiment, the per promotional campaign scheduling may be guided by one or more of the following:

(a) A campaign having a campaign schedule specified by an Ad Agent during campaign order entry.

(b) A campaign specifying the (estimated) impression count or number of impressions that should be delivered to the users or plurality of communications devices.

(c) A campaign suited to a collection of users based on a percentage fit to a demographic and other criterion. The campaign criteria are passed to a targeting engine to return a set of users or communications devices each with a percentage of interest quantification.

(d) A campaign assigning Ads to each interested user based on each user's current inventory of Ads and constraints currently in place.

(e) Because each User has a percentage interest in a campaign, the best fitting campaigns should be allocated to a user. An optimized fit may be obtained by reallocating the least fitting campaign to another (ideally more suitable) user.

(f) A campaign may be constrained by the handset manufacturer, carrier, user's language, handset event, available impression slots and geographic area.

(g) A campaign may limit the number of impressions delivered to a user per time period (i.e., a frequency cap). A time period might include a day-part (e.g., 0600-0900) or specified time, day, week, campaign.

(h) A campaign may specify an estimated user count. The campaign should be delivered to only the selected count of users.

(i) A campaign may have a higher priority and appear earlier in the day-part rotation. For example, each campaign may be assigned a priority level (e.g., 1, 2, 3, etc.) and the campaign that has the highest priority level may choose the day-part in which to display the creative asset associated with the campaign. Companies may pay more money to have their campaign assigned a higher priority level.

In one embodiment, the per user constraints may be guided by one or more of the following:

(a) A user may not receive the same Ad per time period (i.e., a frequency cap).

(b) A user may only receive an Ad per every count of handset events (i.e., max count).

(c) A user may only receive an Ad per a set of handset events.

(d) A user may have a percentage of inventories unused per time period.

(e) A user may not receive competing Ads in succession. A timeout period may apply.

In one embodiment, the content scheduler module 1330 takes into account the concept of a day-part. In the advertising industry, a day is broken out into day parts of several hours. A campaign can specify in which day-parts or time periods an Ad should run, for example, as shown in Table 1 below:

TABLE 1
DAY-PART

Early Morning (6 AM-9 AM)
Daytime (9 AM-4 PM)
Early Fringe (4 PM-6 PM)
Access (6 PM-7 PM)
Prime Time (7 PM-10 PM)
Late Night (10 PM-6 AM)

The campaign schedule is assigned to users or communications devices. Thus, each user has his own schedule, which lists which Ads should be delivered in which day-part. The content scheduler module 1330 generates these schedules while satisfying the current campaign's constraints. The content scheduler module 1330 may also find opportunities to optimize across all users and all campaigns and all constraints.

Typical rules based schedulers are not able to provide optimal schedules needed in the complex environment of mobile communications devices due to the number of devices involved, the varying degree of needs of various campaigns and users, and the minimizing of the labor needed to add new campaigns. For example, typical rules based schedulers have limitations in their ability to provide a viable solution to every user. The present invention provides a method that is able to handle complexities such as timing, maximizing profit, competitive resource allocation, optimizing viewing timing, pay-per-view, pay-per-action, hybrid pay-per-view/action, changing user patterns, changing customer requirements and speed of implementation. An embodiment of the content scheduler module 1330 is described in further detail below.

Referring again to FIG. 13, the client application 1312 serves as the delivery mechanism for the set of content that has been prescribed by content management platform 1302. The client application 1312 executes, services and stores the content schedule, manages the communications device side events that provide the opportunity for an impression, manages the queue of creative assets (i.e., content) to be presented, refreshes the local content cache when directed or required, manages the presentation of content and records into the local data store as data elements all relevant activities that transpire during the application's lifecycle.

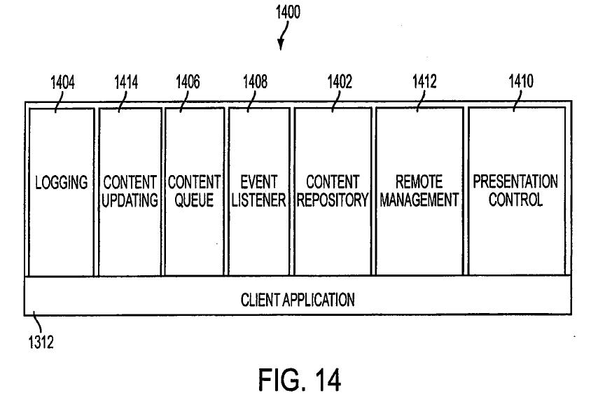

FIG. 14 is a simplified diagram of the client application 1312 in accordance with an embodiment of the present invention. In one embodiment, the components of Client Application 1312 include Repository 1402, Logging Module 1404, Queue Creation Module 1406, Event Listening Module 1408, Presentation Control Module 1410, Remote Management Module 1412 and Content Updating Module 1414.

Content Repository Module 1402 manages the store of content and provides a user interface for browsing and review. Content Repository Module 1402 also enables the user to view a subset of the content displayed to the user at a later point in time.

Logging Module 1404 captures all relevant data elements that are generated by Client Application 1312 into local cache. These data elements may include, for example, impression information, time of day, name of Campaign and the like. The contents of the data cache are regularly uploaded to the Content Management Platform 1302 and stored in Data Warehouse Module 1324 during a content upload cycle.

Content Queue Module 1406 manages the content schedule on client application 1312. For example, Content Queue Module 1406 ensures that content is shown at an appropriate time of day, a certain number of times per day, and is ready to be shown when a user engages communication device 1306.

Event Listener Module 1408 responds to system level events which may occur on the communications device 1306. Event Listener Module 1408 notifies Application Server 1320 of the opportunity to present an impression.

Presentation Control Module 1410 manages window management, application flow control and the show/hide nature of the content window presentation.

Remote Management Module 1412 allows Application Server 1320 to proactively manage Client Application 1312 by remotely calling procedures on the Client Application 1312 in order to perform various functions. For example, Remote Management Module 1412 may be used when Client Application 1312 performs a content update, such as when Client Application 1312 needs to remove a particular campaign from its cache or upload a new version of an application.

Content Updating Module 1414 ensures the freshness of the content that is maintained in the local cache. Client Application 1312 is responsible for communicating with Management Platform 1302 at either a scheduled interval or when it is determined that a communication session is necessary.

A protocol, payload and communications mechanism is provided in order to support the transportation of data, content and instructions to Client Application 1312 from Content Management Platform 1302 and from Client Application 1312 to Content Management Platform 1302. The implemented client/server protocol is carried out on a network transportation layer, such as HTTP or SMPP.

In one embodiment, the implemented protocol provides, but is not limited to, the following example interactions: 1) Client Application 1312 content request update (pull mechanism, from server); 2) Content Management Platform 1302 content request update (push mechanism, to client); 3) Content Management Platform 1302 action request; actions such as APPLICATION_STARTUP or APPLICATION_UPGRADE (push mechanism, to client); 4) Client Application log posting (push mechanism, to server); and 5) third party access to management platform 1302 (push and pull).

In one embodiment, the features of Client Application 1312 are available to third party client side applications in the form of a library. Third party applications might include, but are not limited to: browsers, media players, address book applications, SMS applications, email applications, instant messaging applications, games and productivity applications. The library might include logging, content update, content display, event management, presentation management, content queuing, and event bus management. In one embodiment, third party applications are able to call into the library to facilitate the display of content made available by the server or servers. The third party applications are able to display content from the server when at designated points in their event structures. Discrete events of third party applications might include, but are not limited to, application start or launch, application end, page load, game level up, message send, message received. A server or servers collect event information from third party applications for use in management platform 1302.

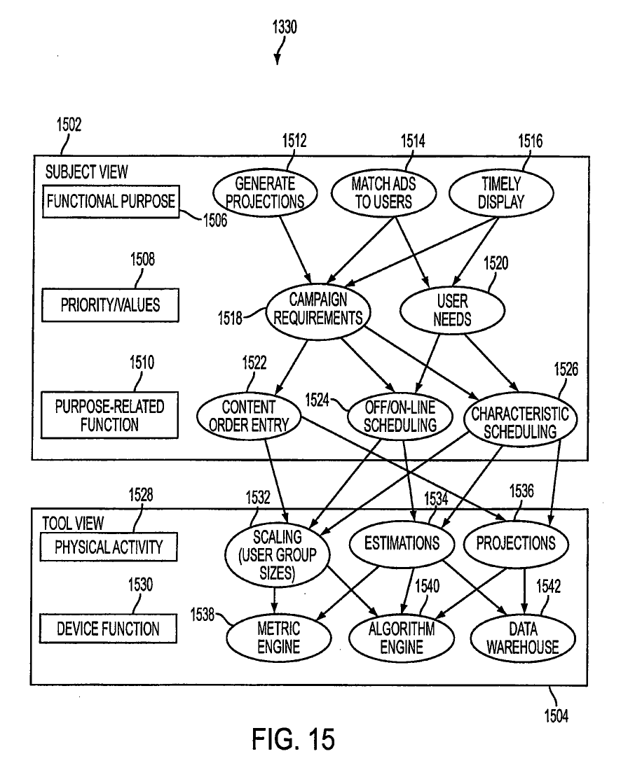

Referring now to Content Scheduler Module 1330 as illustrated in FIG. 15, in one embodiment the present invention takes into account the details of the subject and combines the use of sophisticated tools to calculate the best possible schedule of the events, content and ads to be presented on a mobile phone platform. In one embodiment, Content Scheduler Module 1330 includes two components: a Subject View 1502 and a Tool View 1504.

Subject View 1502 identifies the business attributes that used to characterize and generate scheduling of ads and content on mobile communications devices. To solve the scheduling complexity problem, Subject View 1502 is broken down into three functional categories. The functional categories include Functional Purpose Function 1506, Priority/Values Function 1508 and Purpose-Related Function 1510.

Functional Purpose Function 1506 defines the following attributes: The Basic Needs of the campaign 1512, the need to Match Users 1514 and the need for Timely Display of the content to the user 1516. Generate Projections Attribute 1512 includes making predictions concerning the number of campaigns that need to be run, the number of times people tend to do certain functions (e.g. making phone calls, sending SMS messages, opening clam shell phones, turn phones on, “clicking on links”, and the like), the number of impressions that need to be delivered to a mobile communications device, and other parameters that can be measured to determine if a campaign has met its goals.

Matching ads to users' attribute 1514 includes the ability to match the correct content to appropriate users to insure that users do not get frustrated viewing content that may be of no interest to them. Some examples of this are displaying the same ad repeatedly and displaying golf ads when a user is not interested in golf. It is also important from the campaign perspective that the most likely buyers of the product are reached by the ad to insure that the goals of the campaign are achieved. Examples include sending an ad targeted to women to a woman, sending device-appropriate content (content formatted for the device of the targeted user), and ensuring that ads are received by the correct number of users paid for by an advertiser.

Timely Display Attribute 1516 provides a meaningful experience to the end user and meets campaign requirements. Some examples of the timely display of content on the mobile communications device may include displaying breakfast ads in the morning and not in the evening, making sure ads are available to be shown, making sure if the mobile communications device is out of range or communication that the device still has content to be shown, and insure that old ads are deleted.

The Priority/Values Function 1508 defines the following attributes: Campaign Requirements 1518 and Needs of the users 1520. Campaign Requirements Attributes 1518 may include different forms, such as the pay-per-impression model which targets specific users or groups of users, pay-per-action model which targets a specific users or groups of users and measures when an action is taken, and a hybrid model where the number of impressions and actions formulated together drive the success metrics of the campaign model. A campaign has an inventory of content that is used to provide the impression to the user.

User Needs Attribute 1520 includes taking into account demographics, such as age, gender, marital status, income, religion, users' likes and dislikes. User Needs Attribute 1520 also includes accounting for the user's willingness to view ads and content, and excluding content which may not be of interest to the user or that the user may find offensive.

Purpose-Related Function 1510 defines the Content Order Entry 1522, the On/Off Line Scheduling 1524 and the Characteristic Scheduling 1526 attributes. Content Order Entry Attribute 1522 includes calculating the proper mix of displayed content that is dependent upon projected inventory, scheduled inventory and the intersection of the material that meets the campaign schedule. In some embodiments, users are segmented into multiple groups; however, decisions may be made relevant to campaign requirements, user needs, the ability to scale and projections.

Off/On-Line Scheduling Attribute 1524 operates in two modes: online and offline. In the online mode, a schedule request may be submitted during campaign order entry. Off/On-Line Scheduling Attribute 1524 calculates the number of impressions that may be delivered and responds immediately with a response. In the offline mode, Off/On-line Scheduling Attribute 1524 receives a schedule request and generates a schedule for each user group for the related campaign.

Characteristic Scheduling Attribute 1526 determines a mobile phone's ability to show the ad or content properly (based on network and device performance characteristics), supports day-part needs based on loading, meeting campaign and user constraints, reshuffling the scheduling of impressions in order to meet showings during a specific time-frame. The Characteristic Scheduling Attribute 1526 supports various campaign models. In one embodiment, Characteristic Scheduling Attribute 1526 may also include the ability to generate a schedule for a user or users on demand based on the available set of ads and the user's or users' stated or probable interest.

Tool View 1504 identifies the activities used to generate the calculations to monitor and track system parameters. Tool View 1504 includes two functional categories: Physical Activity function 1528 and Device function 1530. Physical Activity function includes Scaling 1532, Estimations 1534 and Projections 1536.

The number of campaigns and users varies based on customer, geographic area, time of year, and market penetration to name a few. Scaling function (user group sizes) 1532 handles large numbers of users from thousands up to 10 s to 100 s of millions of users. From a campaign perspective, the system handles tens of campaigns up to 10 s of thousands of campaigns.

Estimations function 1534 looks at historical data and, tracks trends and predict future outcomes. For example, the Estimations function 1534 might predict an increased number of campaigns prior to the Christmas holiday; this might result in an increased amount of salable inventory and/or might impact the pricing model salable inventory.

Projections Functions 1536 takes into account market trends, economic considerations, and other variables that affect the number of users, campaigns and revenue.

Device Function 1530 includes Metric Engine 1538, Algorithm Engine 1540, and Data Warehouse 1542. In one embodiment, Metric Engine 1538 uses various mathematical formulas and algorithms to calculate, predict and estimate event activity (and inventory corresponds to event activity, for hypothetical and actual scheduling of ads and content for mobile communications devices. In one embodiment, Metric Engine 1538 uses various mathematical formulas and algorithms to calculate, predict and estimate logical groupings of behaviorally similar users, for hypothetical and actual scheduling of ads and content for mobile communications devices.

Algorithm Engine 1540 uses various mathematical formulas and algorithms to calculate, predict and estimate performance of hypothetical and actual scheduling of ads and content for mobile communications devices. The Algorithm Engine 1540 produces specific tools, such as spreadsheets, graphs and other analysis tools to adjust parameters, meet campaign, user and monetary objectives. The Algorithm Engine 1540 contains capabilities such as targeting, learning and simulation.

The storage of system characteristics is used to predict performance, modify actions to meet goals, and provide historical reference material to improve decision-making. Data Warehouse 1542 records information from the user's mobile communications devices, campaign characteristics, and other system performance data.

The output of this process is a schedule that is optimized for each user for viewing ads and content, measurements on the performance of campaign metrics and a basis for describing the performance of the system to potential customers and network providers.

Content Scheduler 1330 provides a best fit solution when a typical rule based scheduler may not provide an optimal solution. The Cognitive Scheduler enables a computational method designed to find optimal distribution schedule. The Cognitive Scheduler saves man hours in developing rules based solutions to every campaign, adapts in real-time to changing dynamics, provides an optimum fit for each user, guarantees to give the best fit available and that a solution will be provided. The Cognitive Scheduler may be extended to manage any resource such as handset memory, network bandwidth, profit, delivery, interest, and transaction rate; and may also be extended to support additional constraints such as ‘maximize profit’, ‘optimize handset memory’, ‘optimize campaign delivery’, ‘optimize user interest’, and ‘minimize transaction rate’.

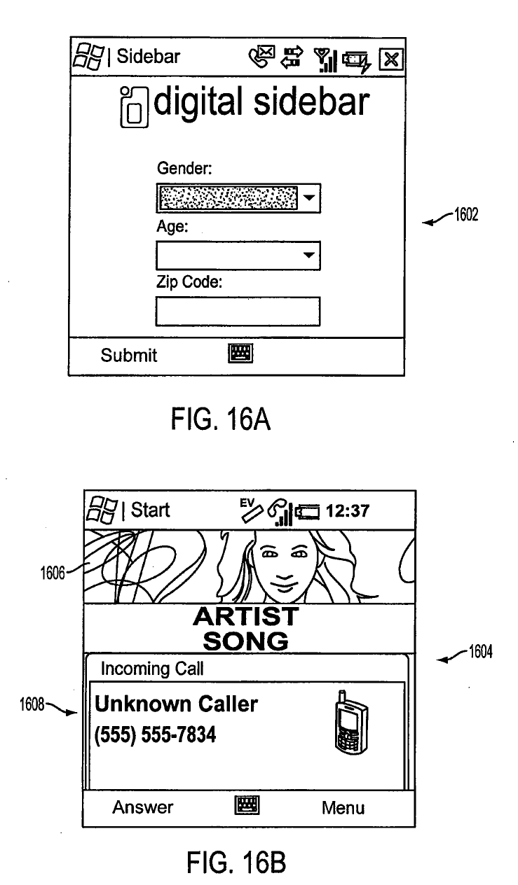

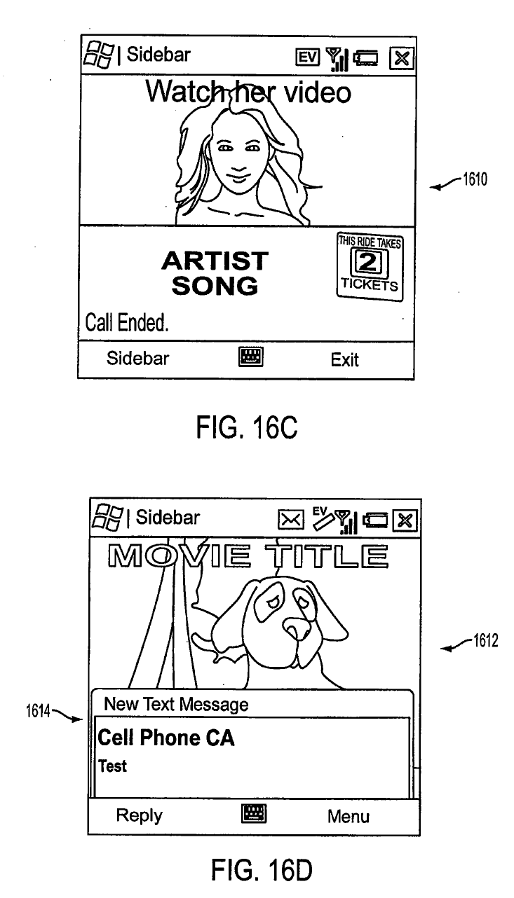

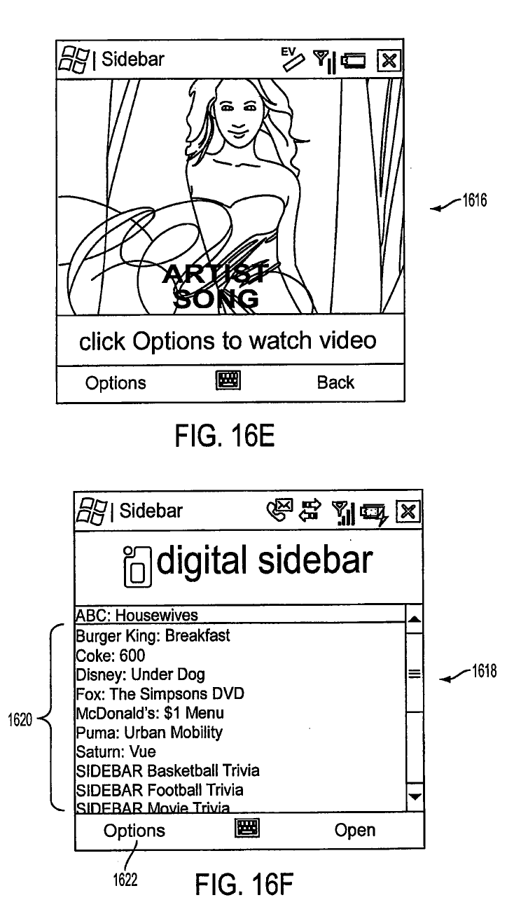

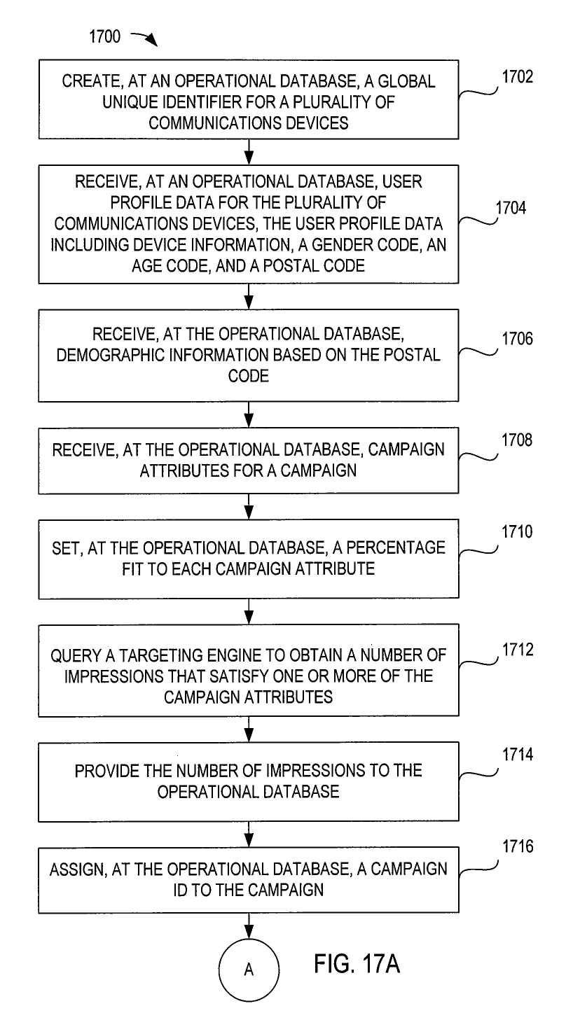

FIGS. 16A-16F provide an illustration of an exemplary application of the present invention. As shown in FIG. 16A, upon first launch of an embodiment of the present invention, a user may be prompted via user interface 1602 to register. In one embodiment, the user may be prompted to provide, for example, gender, age, and geographic information.

A device event may activate the application. In one embodiment, the device event may include a unique occurrence of an Inbound call, Outbound call, Inbound SMS, and Outbound SMS, Inbound MMS, Outbound MMS, and other platform specific events, such as the “HOLSTER_REMOVED” event on a BlackBerry device.

As shown in FIG. 16B, when a device event occurs, content windows 1604 may be displayed. In one embodiment, content windows 1604 may include ICALL—Inbound Call window/OCALL—Outbound Call window 1606, which is typically the smallest creative as it shares the display screen real estate with the calling information display 1608, which may include Caller ID+Phone Number. Windows 1606 be considered a “teaser” window as it may be non-actionable (i.e. not able to be clicked on to initiate an action).

As shown in FIG. 16C, DROPBACK window 1610 may be activated upon the termination of a call. The DROPBACK window 1610 creative may occupy the full screen of the device and is actionable (i.e. can be clicked on and has associated soft keys). The DROPBACK window 1610 may be associated with a creative campaign (Ad) that is previously displayed on the ICALL and OCALL windows 1606.

As shown in FIG. 16D, an ISMS or OSMS window 1612 may be activated upon the receipt or sending, respectively, of an SMS text message 1614. The ISMS/OSMS window 1612 creative occupies the full screen of the device and may be actionable.

The ISMS, OSMS and DROPBACK windows may have a time to live (TTL) function that allows the window to appear between three (3) and five (5) seconds or as desired. If the content window has not been clicked-on or dismissed within the TTL constraint, the content window may be removed from view.

In this embodiment, a unit or impression is a content display instance triggered by a device event.

ICALL+DROPBACK

OCALL+DROPBACK

ISMS

OSMS

As shown in FIGS. 16A-16E, these include ICALL/OCALL—Partial screen image shared across these content windows, DROPBACK/ISMS/OSMS—Full screen image shared across these content windows, and KEYSTONE—Full Screen 1616.

As shown in FIG. 16F, in one embodiment, when a user launches the application the user may be presented with a repository menu 1618 of active campaigns 1620 that are resident on the device. The repository allows the user to browse campaigns at his leisure, or revisit a campaign that appealed to him. When the user clicks on the name of the campaign in the repository menu 1618, a KEYSTONE image 1616 may be displayed until the user hits a soft key for further action or exits the application. KEYSTONE image 1616 may include textual directives 1617 for the user, such as “Click Options/Video to see a trailer” and the like.

In addition, the user may select options button or a corresponding soft key 1622 to display more information about the KEYSTONE image 1616. For example, in one embodiment, selecting options button 1622 may cause a drop down menu to appear and provide the following or similar choices: Share, More Info, Call and Video as previously described. It should be understood that the KEYSTONE image 1616 may be viewed as a static, audio visual, or an animated display.

The invention has been disclosed in an illustrative manner. Accordingly, the terminology employed throughout should be read in an exemplary rather than a limiting manner. Although minor modifications of the invention will occur to those of ordinary skill in the art, it shall be understood that what is intended to be circumscribed within the scope of the patent warranted hereon are all such embodiments that reasonably fall within the scope of the advancement to the art hereby contributed, and that scope shall not be restricted, except in light of the appended claims and their equivalents.

Those of ordinary skill would appreciate that the various illustrative logical blocks, modules, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

The various illustrative logical blocks, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A computer-based method of scheduling creative assets for targeted distribution of a plurality of campaigns to a plurality of communications devices, the method comprising:
receiving, at a server, device information from each of the plurality of communications devices;
creating, at a database, a global unique identifier for each of the plurality of communications devices;
receiving, at the database, an age code, a gender code, and a postal code corresponding to a user of each of the plurality of communications devices;
receiving, at the database, demographic information corresponding to users residing within the postal code;
receiving, at the database, a campaign attribute for a plurality of campaigns;
querying a targeting engine to obtain a number of impressions that satisfy the campaign attribute for each of the plurality of campaigns;
receiving, at the database, a creative asset for each of the plurality of campaigns;
formatting, at a content processor, the creative asset for each of the plurality of campaigns using the device information from each of the plurality of communications devices;
receiving, at the database, a business rule or a constraint for each of the plurality of campaigns;
creating a schedule for the plurality of campaigns based on the user profile data, the demographic information, the campaign attributes, the business rules or the constraints; and
transmitting the schedule and the creative assets to the plurality of communications devices.

2. The method of claim 1, wherein the device information includes a model number.

3. The method of claim 1, wherein the global unique identifier includes a phone number.

4. The method of claim 1, wherein the demographic information is selected from a group consisting of an average household income, an average number of children per household, a type of job, an average number of cars, a type of car driven, and combinations thereof.

5. The method of claim 1, wherein the campaign attributes are selected from a group consisting of a type of music, a type of car, a type of soda, a movie, a television show, a sporting event, a sport, a social network, a geographic region, a like, a dislike, and combinations thereof.

6. The method of claim 1, further comprising setting a percentage fit for the campaign attribute.

7. The method of claim 1, wherein an impression is an opportunity to display the creative asset on at least one of the plurality of communications devices in response to an action or event that occurs on the at least one of the plurality of communications devices.

8. The method of claim 1, wherein the creative asset is selected from a group consisting of an advertisement, an electronically scannable coupon, a video, and combinations thereof.

9. The method of claim 1, wherein the business rule is not displaying competing creative assets in succession.

10. The method of claim 1, wherein the business rule is not displaying the same creative assets per a time period.

11. The method of claim 1, wherein the constraint is specifying a day-part for displaying the creative asset for each of the plurality of campaigns.

12. The method of claim 1, wherein the constraint is providing a priority level for each of the campaigns in the schedule.

13. The method of claim 1, further comprising creating, at each of the plurality of communications devices, a list of viewed creative assets and a list of unviewed creative assets.

14. The method of claim 13, further comprising transmitting the creative assets on the list of unviewed creative assets to the plurality of communications devices.

15. A computer-readable medium having stored thereon computer executable instructions, the instructions, when executed by a processor, causing the processor to perform a method of scheduling creative assets for targeted distribution of a plurality of campaigns to a plurality of communications devices, the method comprising:
receiving, at a server, device information from each of the plurality of communications devices;
creating, at a database, a global unique identifier for each of the plurality of communications devices;
receiving, at the database, an age code, a gender code, and a postal code corresponding to a user of each of the plurality of communications devices;
receiving, at the database, demographic information corresponding to users residing within the postal code;
receiving, at the database, a campaign attribute for a plurality of campaigns;
querying a targeting engine to obtain a number of impressions that satisfy the campaign attribute for each of the plurality of campaigns;
receiving, at the database, a creative asset for each of the plurality of campaigns;
formatting, at a content processor, the creative asset for each of the plurality of campaigns using the device information from each of the plurality of communications devices;
receiving, at the database, a business rule or a constraint for each of the plurality of campaigns;
creating a schedule for the plurality of campaigns based on the user profile data, the demographic information, the campaign attributes, the business rules or the constraints; and
transmitting the schedule and the creative assets to the plurality of communications devices.

16. The computer-readable medium of claim 15, wherein the device information includes a model number.

17. The computer-readable medium of claim 15, wherein the global unique identifier includes a phone number.

18. The computer-readable medium of claim 15, wherein the demographic information is selected from a group consisting of an average household income, an average number of children per household, a type of job, an average number of cars, a type of car driven, and combinations thereof.

19. The computer-readable medium of claim 15, wherein the campaign attributes are selected from a group consisting of a type of music, a type of car, a type of soda, a movie, a television show, a sporting event, a sport, a social network, a geographic region, a like, a dislike, and combinations thereof.

20. The computer-readable medium of claim 15, further comprising setting a percentage fit for the campaign attribute.

21. The computer-readable medium of claim 15, wherein an impression is an opportunity to display the creative asset on at least one of the plurality of communications devices in response to an action or event that occurs on the at least one of the plurality of communications devices.

22. The computer-readable medium of claim 15, wherein the creative asset is selected from a group consisting of an advertisement, an electronically scannable coupon, a video, and combinations thereof.

23. The computer-readable medium of claim 15, wherein the business rule is not displaying competing creative assets in succession.

24. The computer-readable medium of claim 15, wherein the business rule is not displaying the same creative assets per a time period.

25. The computer-readable medium of claim 15, wherein the constraint is specifying a day-part for displaying the creative asset for each of the plurality of campaigns.

26. The computer-readable medium of claim 15, wherein the constraint is providing a priority level for each of the campaigns in the schedule.

27. The computer-readable medium of claim 15, further comprising creating, at each of the plurality of communications devices, a list of viewed creative assets and a list of unviewed creative assets.

28. The computer-readable medium of claim 27, further comprising transmitting the creative assets on the list of unviewed creative assets to the plurality of communications devices.
